(19) United States
(12) Patent Application Publication
(10) Pub. No.: US 2015/0047590 A1
(43) Pub. Date: Feb. 19, 2015

(54) APPARATUS AND METHOD FOR CONTROLLING FUEL SUPPLY OF BI-FUEL VEHICLE

(71) Applicants: Kia Motors Corporation, Seoul (KR); Hyundai Motor Company, Seoul (KR)

(72) Inventor: Deok Ryol KIM, Yongin-city (KR)

(73) Assignees: Kia Motors Corporation, Seoul (KR); Hyundai Motor Company, Seoul (KR)

(21) Appl. No.: 14/109,365

(22) Filed: Dec. 17, 2013

(30) Foreign Application Priority Data
Aug. 16, 2013 (KR) 10-2013-0097432

(51) Int. Cl. F02M 13/06

(52) U.S. Cl. CPC F02M 13/06
USPC 123/1 A

(57) ABSTRACT

An apparatus and a method for controlling fuel supply of a bi-fuel vehicle includes: a gasoline fuel unit injecting gasoline fuel to a combustion chamber of an engine; an LPG fuel unit injecting LPG fuel to the combustion chamber of the engine; and an engine controlling unit selectively using the gasoline fuel and the LPG fuel according to an operation mode of a vehicle, and the engine controlling unit enters a limp home mode according to a state of the LPG fuel unit and uses fuel different from fuel used in a driving mode as driving fuel in the limp home mode.

### CROSS-REFERENCE TO RELATED APPLICATION

The present application claims priority of Korean Patent Application Number 10-2013-0097432 filed Aug. 16, 2013, the entire contents of which application is incorporated herein for all purposes by this reference.

### BACKGROUND OF INVENTION

1. Field of Invention

The present invention relates to an apparatus and a method for controlling fuel supply of a bi-fuel vehicle.

2. Description of Related Art

In recent years, a bi-fuel vehicle using both gasoline and gas has been developed. Gas includes compressed natural gas (CNG), liquefied petroleum gas (LPG), and the like.

The bi-fuel vehicle includes a gasoline fuel system and an LPG fuel system. The bi-fuel vehicle selectively switches gasoline FUEL and LPG fuel by controlling the gasoline fuel system and the LPG fuel system through an engine controlling unit (ECU).

In general, the bi-fuel vehicle drives an engine with the gasoline fuel while starting and drives the engine by switching the gasoline engine to the LPG fuel while driving. During such a driving process, when malfunction occurs in a fuel component of the LPG system, the ECU switches the mode to a limp home mode.

The limp home mode is a substitution mode for preventing safety of a driver from being undermined due to a sudden stop of an engine caused by malfunction of parts. The ECU limits a vehicle speed to approximately 60 to 80 km/h or less in the limp home mode and keeps an RPM of the engine at approximately 1,500 to 2,000 rpm which is higher than a general level even when the vehicle is in an idle stop state.

Accordingly, a driver can be adversely affected due to the limitation of the vehicle speed in the limp home mode and with an increase of RPM of the engine, fuel efficiency may deteriorate.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for an apparatus and a method for controlling fuel supply of a bi-fuel vehicle that can prevent speed limitation and fuel efficiency reduction of a vehicle by switching and controlling fuel to different fuel from driving fuel in a limp home mode.

Various aspects of the present invention provide for an apparatus for controlling fuel supply of a bi-fuel vehicle, including: a gasoline fuel unit injecting gasoline fuel to a combustion chamber of an engine; an LPG fuel unit injecting LPG fuel to the combustion chamber of the engine; and an engine controlling unit selectively using the gasoline fuel and the LPG fuel according to an operation mode of a vehicle, and the engine controlling unit enters a limp home mode according to a state of the LPG fuel unit and uses fuel different from fuel used in a driving mode as driving fuel in the limp home mode.

In addition, the engine controlling unit may use the gasoline fuel as starting fuel in a starting mode of the vehicle. The engine controlling unit may use the LPG fuel as the driving fuel in the driving mode of the vehicle.

The engine controlling unit may switch the LPG fuel to the gasoline fuel in the limp home mode. The engine controlling unit may enter the limp home mode when malfunction of the LPG fuel unit is diagnosed. The apparatus may further include an engine warning lamp which is lit on when entering the limp home mode.

Various aspects of the present invention provide for a method for controlling fuel supply of a bi-fuel vehicle including a gasoline fuel unit injecting gasoline fuel to a combustion chamber of an engine and an LPG fuel unit injecting LPG fuel to the combustion chamber of the engine, including: determining whether the LPG fuel unit has malfunction while a vehicle is driven by entering a driving mode; entering a limp home mode when malfunction of the LPG fuel unit is diagnosed; and driving the vehicle by using fuel different from fuel used when entering the driving mode.

The entering of the driving mode may include driving the vehicle by using the LPG fuel as driving fuel. The driving of the vehicle by using the different fuel may include switching the driving fuel from the LPG fuel to the gasoline fuel.

The entering of the limp home mode may include lighting on an engine warning lamp. The method may further include starting the vehicle by using the gasoline fuel as starting fuel.

According to various aspects of the present invention, by switching and controlling driving fuel to another fuel in a limp home mode, inconvenience of a driver is not caused due to speed limitation of a vehicle and an engine RPM need not be increased, thereby preventing fuel efficiency from being reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating an exemplary apparatus for controlling fuel supply of a bi-fuel vehicle according to the present invention.

FIG. 2 is a flowchart illustrating an exemplary method for controlling fuel supply of a bi-fuel vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

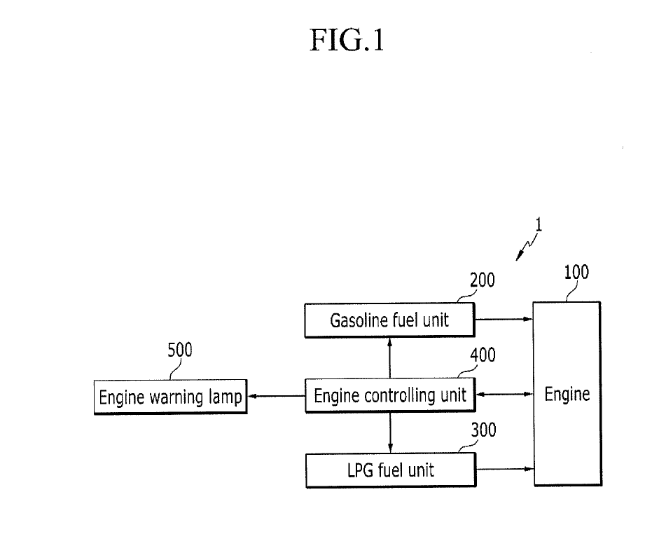

FIG. 1 is a diagram illustrating an apparatus for controlling fuel supply of a bi-fuel vehicle according to various embodiments of the present invention.

Referring to FIG. 1, a fuel supply controlling apparatus 1 according to various embodiments of the present invention includes an engine 100, a gasoline fuel unit 200, an LPG fuel unit 300, an engine controlling unit 400, and an engine warning lamp 500. The engine 100 includes components associated with air intake and air exhaust, and generates power by gasoline fuel or LPG fuel.

The gasoline fuel unit 200 supplies the gasoline engine to a combustion chamber of the engine 100. The gasoline fuel unit 200 includes all apparatuses for supplying and controlling the gasoline fuel. For example, the gasoline fuel unit 200 may include a gasoline fuel tank, a fuel line for supplying gasoline, and a gasoline injector for injecting gasoline.

The gasoline fuel unit 200 may adopt a gasoline multipoint injection (MPI) method in which air and the gasoline fuel are mixed and thereafter, injected to the combustion chamber of the engine 100 or a gasoline direct injection (GDI) method in which the gasoline fuel is directly injected to the combustion chamber of the engine 100.

The LPG fuel unit 300 supplies the LPG fuel to the combustion chamber of the engine 100. The LPG fuel unit 300 includes all apparatuses for supplying and controlling the LPG fuel. For example, the LPG fuel unit 300 includes an LPG fuel tank, a fuel line for supplying the LPG fuel, an LPG injector for injecting the LPG fuel, a vaporizer that vaporizes the LPG fuel in a liquid state, and a mixer that mixes the LPG fuel and air.

The LPG fuel unit 300 may adopt a liquefied petroleum gas injection (LPGi) method or a liquefied petroleum injection (LPI) method. In the LPI method, the mixer and the vaporizer may be omitted and the LPG fuel unit 300 may include a fuel pressure sensor sensing a pressure of the LPG fuel supply line and a fuel temperature sensor sensing the temperature of fuel.

The engine controlling unit 400 includes a signal generation logic to control an injection time and an injection amount of the gasoline fuel and the LPG fuel. The engine controlling unit 400 generates control signals for selectively supplying the gasoline fuel and the LPG fuel to the combustion chamber of the engine 100 according to an operation mode of the vehicle. For example, the engine controlling unit 400 may perform starting of the vehicle by using the gasoline fuel in a starting mode and perform driving of the vehicle by switching the gasoline fuel to the LPG fuel in a driving mode.

Further, the engine controlling unit 400 according to various embodiments of the present invention may perform driving of the vehicle by switching the LPG fuel to the gasoline fuel in a limp home mode. The engine controlling unit 400 enters the limp home mode from the driving mode when malfunction occurs in at least one of components in the LPG fuel unit 300 while the vehicle is driven with the LPG fuel.

The engine controlling unit 400 supplies the gasoline fuel instead of the LPG fuel to the combustion chamber of the engine 100 to drive the vehicle in the limp home mode. As a result, the vehicle may be safely moved without limitation of a driving speed of the vehicle or restriction of a driving operation such as increasing of the rpm of the engine when the vehicle is in an idle stop.

In addition, the engine controlling unit 400 may warn abnormality of the vehicle to the driver through the engine warning lamp 500 when the driving mode is switched to the limp home mode. To this end, the engine controlling unit 400 may perform malfunction diagnosis by sensing an abnormal operation of the components in the LPG fuel unit 300 and generate a control signal for controlling the engine warning lamp 500 in the malfunction diagnosis.

The engine warning lamp 500 is disposed in a instrument panel of the vehicle, and is controlled by the engine controlling unit 400 to be selectively lit on. The driver may recognize the limp home mode through lighting-on of the engine warning lamp 500.

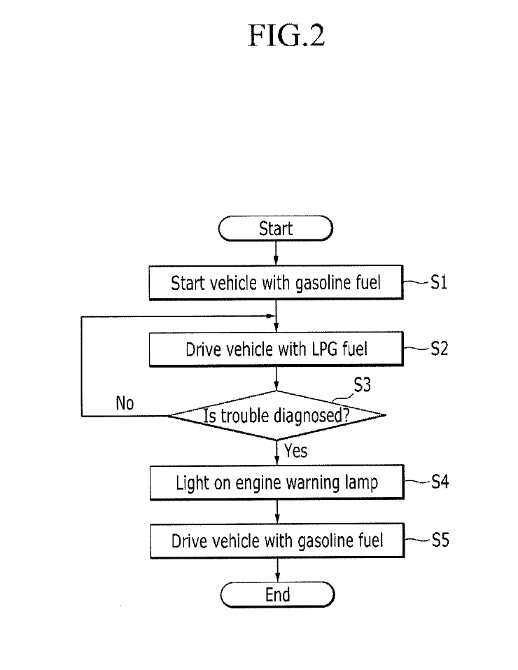

FIG. 2 is a flowchart illustrating a method for controlling fuel supply of a bi-fuel vehicle according to various embodiments of the present invention.

Referring to FIG. 2, first, an engine controlling unit 400 uses gasoline fuel as starting fuel in a vehicle starting mode. The engine controlling unit 400 supplies gasoline fuel to a combustion chamber of an engine 100 through a gasoline fuel unit 200, and as a result, vehicle starting is performed (step S1).

Next, the engine controlling unit 400 switches the gasoline fuel to LPG fuel in a driving mode of a vehicle (step S2). The engine controlling unit 400 supplies the LPG fuel to the combustion chamber of the engine 100 by switching and driving the gasoline fuel unit 200 to an LPG fuel unit 300. As a result, the LPG fuel is used as driving fuel to drive the vehicle.

Next, the engine controlling unit 400 determines whether a component which is erroneous is present among components in the LPG fuel unit 300 (step S3). According to a determination result, the engine controlling unit 400 diagnoses malfunction when at least one of the components in the LPG fuel unit 300 is erroneous and switches a driving mode to a limp home mode.

Next, the engine controlling unit 400 allows a driver to recognize switching the driving mode to the limp home mode by lighting on an engine warning lamp 500 (step S4).

Next, the engine controlling unit 400 switches the driving fuel from the LPG fuel to the gasoline fuel (step S5). Then, the vehicle may be safely moved by driving the vehicle by using the gasoline fuel instead of the LPG fuel.

Meanwhile, according to the determination result in step S3, when the component in the LPG fuel unit 300 is not erroneous, the engine controlling unit 400 continuously drives the vehicle by using the LPG fuel.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. An apparatus for controlling fuel supply of a bi-fuel vehicle, comprising:
a gasoline fuel unit injecting gasoline fuel to a combustion chamber of an engine;
an LPG fuel unit injecting LPG fuel to the combustion chamber of the engine; and
an engine controlling unit selectively using the gasoline fuel and the LPG fuel according to an operation mode of a vehicle;
wherein the engine controlling unit enters a limp home mode according to a state of the LPG fuel unit and uses fuel different from fuel used in a driving mode as driving fuel in the limp home mode.

2. The apparatus of claim 1, wherein the engine controlling unit uses the gasoline fuel as starting fuel in a starting mode of the vehicle.

3. The apparatus of claim 1, wherein the engine controlling unit uses the LPG fuel as the driving fuel in the driving mode of the vehicle.

4. The apparatus of claim 3, wherein the engine controlling unit switches the LPG fuel to the gasoline fuel in the limp home mode.

5. The apparatus of claim 1, wherein the engine controlling unit enters the limp home mode when malfunction of the LPG fuel unit is diagnosed.

6. The apparatus of claim 1, further comprising:
an engine warning lamp which is lit on when entering the limp home mode.

7. A method for controlling fuel supply of a bi-fuel vehicle including a gasoline fuel unit injecting gasoline fuel to a combustion chamber of an engine and an LPG fuel unit injecting LPG fuel to the combustion chamber of the engine, the method comprising:
determining whether the LPG fuel unit has malfunction while a vehicle enters a driving mode and is driven;
entering a limp home mode when malfunction of the LPG fuel unit is diagnosed; and
driving the vehicle by using fuel different from fuel used when entering the driving mode.

8. The method of claim 7, wherein the entering of the driving mode includes driving the vehicle by using the LPG fuel as driving fuel.

9. The method of claim 8, wherein the driving of the vehicle by using the different fuel includes switching the driving fuel from the LPG fuel to the gasoline fuel.

10. The method of claim 7, wherein the entering of the limp home mode includes lighting on an engine warning lamp.

11. The method of claim 7, further comprising:
starting the vehicle by using the gasoline fuel as starting fuel.
